(19) United States
(12) Patent Application Publication
(10) Pub. No.: US 2026/0312183 A1
(43) Pub. Date: Oct. 8, 2026

(54) A SOLID ELECTROLYTE BATTERY AND A MANUFACTURING METHOD THEREOF

(71) Applicant: MAXELL, LTD., Otokuni-gun, Kyoto (JP)

(72) Inventors: Hideaki Katayama, Otokuni-gun (JP); Takumi Otsuka, Otokuni-gun (JP); Koji Futagawa, Otokuni-gun (JP); Seiji Ishizawa, Otokuni-gun (JP)

(73) Assignee: MAXELL, LTD., Otokuni-gun, Kyoto (JP)

(21) Appl. No.: 19/485,034

(22) PCT Filed: May 9, 2024
(86) PCT No.: PCT/JP2024/017288

§ 371 Date: Nov. 17, 2025

(30) Foreign Application Priority Data
May 18, 2023 (JP) 2023-082135

(51) Int. Cl. H01M 10/658; H01M 10/0562

(52) U.S. Cl. CPC H01M 10/658; H01M 10/0562; H01M 2300/0068

(57) ABSTRACT

The present application provides a solid electrolyte battery with good productivity and reliability, as well as its manufacturing method. The solid electrolyte battery of the present invention relates to Goals 3, 7, 11 and 12 of the SDGs. There is provided a solid electrolyte battery of the present invention comprising an electrode body comprising a plurality of pellet-shaped power generation elements stacked, and an exterior body. Each of the plurality of the power generation elements comprises a positive electrode layer, a solid electrolyte layer, and a negative electrode layer stacked in order. The electrode body is housed in a container that is insulating, which is enclosed by an exterior body, wherein a foamed sheet (A) is arranged at at least a part between an inner surface of the container and the electrode body, such that the electrode body is fixed within the container by the foamed sheet (A).

### TECHNICAL FIELD

The present invention relates to solid electrolyte batteries that have good productivity and reliability, as well as their manufacturing method.

### TECHNICAL BACKGROUND

In recent years, with the development of portable electronic devices such as mobile phones and notebook personal computers, as well as with the practical application of electric vehicles, there has been a growing need for batteries that are compact, lightweight, high-capacity and high-energy-density.

Currently, in lithium batteries or especially lithium-ion batteries that can meet this requirement, lithium-containing composite oxides such as lithium cobalt oxide (LiCoO₂) and lithium nickel oxide (LiNiO₂) are used as the positive electrode active material; graphite or the like is used as the negative electrode active material; and an organic electrolyte solution containing an organic solvent and a lithium salt is used as the non-aqueous electrolyte.

With further development of lithium-ion battery application equipments, there is a demand for not only for further improving the life of the lithium-ion batteries, higher capacity and higher energy density, but for improving the reliability of lithium-ion batteries with longer life, higher capacity and higher energy density.

However, the organic electrolyte used in the lithium-ion battery contains an organic solvent that is a flammable substance, and therefore there is a possibility that the organic electrolyte generates abnormal heat when it comes to an abnormal situation such as a short circuit in the battery. In addition, with the recent increase in the energy density of lithium-ion batteries and the increasing trend of the amount of organic solvents in organic electrolytes, it has become more demands for improving the reliability of lithium-ion batteries.

In the situation described above, solid electrolyte batteries using molded solid electrolytes that do not employ organic solvents are also being considered as an alternative to organic solvent-based electrolytes. Solid electrolyte batteries have high reliability because their solid electrolytes do not pose the risk of abnormal heat generation, unlike organic solvent-based electrolytes. Therefore, there are high expectations in product fields that require high-capacity secondary batteries.

In addition, Solid electrolyte batteries are not only highly safe, but also highly reliable, highly environmentally resistant, and have a long life, so they are expected to be maintenance-free batteries that can contribute to the development of society while continue to contribute to safety and security. Of the seventeen Sustainable Development Goals (SDGs) established by the United Nations, the provision of solid electrolyte batteries to the society can contribute to the achievement of Goal 3 (Ensure healthy lives and promote well-being for all at all ages), Goal 7 (Ensure access to affordable, reliable, sustainable and modern energy for all), Goal 11 (Make cities and human settlements inclusive, safe, resilient and sustainable) and Goal 12 (Ensure sustainable consumption and production patterns).

By the way, in batteries such as solid electrolyte batteries, it may be possible that pressure members that apply pressure to power generation elements including electrodes are used inside the exterior body for the purpose of improving characteristics and productivity.

For example, Patent Document 1 proposes a sealed storage battery in which a pressure spacer is arranged in the lamination direction of an electrode plate group including electrode plates (electrodes) such that it deforms to increase the occupied volume within the cell chamber, thereby enhancing the adhesion between the electrode plates and the retainer.

Furthermore, Patent Document 2 proposes a sulfide all-solid battery in which a pressurizing member made of a material is provided to expand without generating gas upon heating, which is located between the electrode body with a sulfide solid electrolyte and the exterior body. In the sulfide all-solid battery according to Patent Document 2, the electrode body is sealed within the exterior body and then heating it, such that the pressurizing member expands to give pressure, which allows for efficient placement of the pressurizing member to improve productivity.

### RELATED ART REFERENCES

### Patent References

Patent Reference No. 1: Japanese Laid-Open Patent Publication No. H6-290805
Patent Reference No. 2: Japanese Laid-Open Patent Publication No. 2022-156220

### SUMMARY OF THE INVENTION

### The Objectives to Solve by the Invention

However, in the batteries disclosed in Patent Documents Nos. 1 and 2, before the sealing of the exterior body, the electrodes (power generation elements) that make up the electrode body are only stacked together. Therefore, during various manufacturing stages of the battery, such as when housing the electrode body into the exterior body, during the wiring after housing the electrode body, or during the sealing of the exterior body, there is a risk of misalignment between the power generation elements that constitute the electrode body and between the electrodes. Therefore, there is room for improving the battery's productivity and the reliability of the batteries as produced.

The present invention has been made in view of the circumstances above, and its purpose is to provide a solid electrolyte battery with good productivity and reliability, as well as a method for manufacturing such a battery.

### Means to Solve the Objectives

There is provided a solid electrolyte battery of the present invention comprising an electrode body comprising a plurality of pellet-shaped power generation elements stacked, and an exterior body. Each of the plurality of the power generation elements comprises a positive electrode layer, a solid electrolyte layer, and a negative electrode layer stacked in order. The electrode body is housed in a container that is insulating, which is enclosed by an exterior body, wherein a foamed sheet (A) is arranged at at least a part between an inner surface of the container and the electrode body, such that the electrode body is fixed within the container by the foamed sheet (A).

There is also provided a method for manufacturing a solid electrolyte battery, which comprises an electrode body formed of multiple layers of pellet-shaped power generation elements, an exterior body, and a container that is insulating that contains the electrode body and is enclosed by the exterior body. The method comprises: a step of arranging a sheet that foams upon heating in at least a portion between the container and the electrode body; and a step of heating after containing the electrode body in the container to foam the sheets and fix the sides of the electrode body to the inner surface of the container.

### Effects of the Invention

According to the present invention, it is possible to provide a solid electrolyte battery with good productivity and reliability, as well as its manufacturing method.

### BRIEF DESCRIPTION OF THE DRAWINGS

FIG. 1 It is a perspective view schematically representing an example of the container that can be used in the solid electrolyte battery of the present invention.

FIG. 2 It is a perspective view showing the state where the electrode body is housed in the container shown in FIG. 1.

FIG. 3 It is a cross-sectional view schematically representing an example of the solid electrolyte battery of the present invention.

### EMBODIMENTS TO CARRY OUT THE INVENTION

The solid electrolyte battery of the present invention comprises an electrode body comprising multiple pellet-shaped power generation elements being stacked, each of which is configured by a positive electrode layer, a solid electrolyte layer and a negative electrode layer in order, as well as an exterior body. In addition, the electrode body is housed within an insulating container and is enclosed in the exterior body with arrangement of a foamed sheet (A) at at least a portion between the inner surface of the container and the electrode body. The electrode body is fixed within the container such that one side surface of the foamed sheet (A) is in close contact with the inner surface of the container and the other side surface of the foamed sheet (A) is in close contact with the side surface of the electrode body.

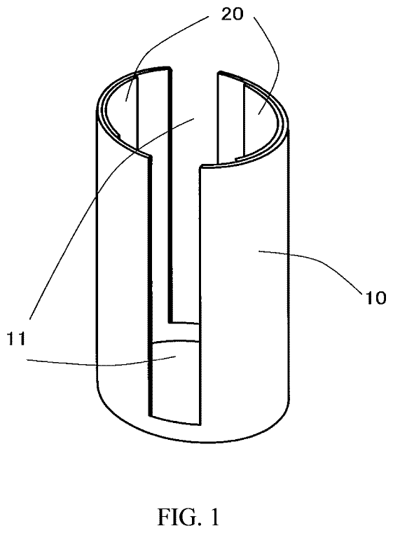

FIG. 1 is a perspective view schematically representing an example of the container that can be used in the solid electrolyte battery of the present invention. The container 10 shown in FIG. 1 has a bottomed cylindrical shape, allowing it to house an electrode body inside. Additionally, the container 10 is made of an insulating material such as resin, which has a resin sheet 20 on at least a part of the inner surface thereof. The resin sheet 20 is to foam upon heating to form a foamed sheet (A) being insulating. The resin sheet 20 can be provided with a bonding layer of an adhesive agent, which allows the resin sheet 20 to be adhered to the inner surface of the container, thereby ensuring close contact between the two.

In addition, the container 10 is provided with slits 11, 11 to expose the positive electrode layer connection terminal and the negative electrode layer connection terminal of the contained electrode body to the outside of the container 10.

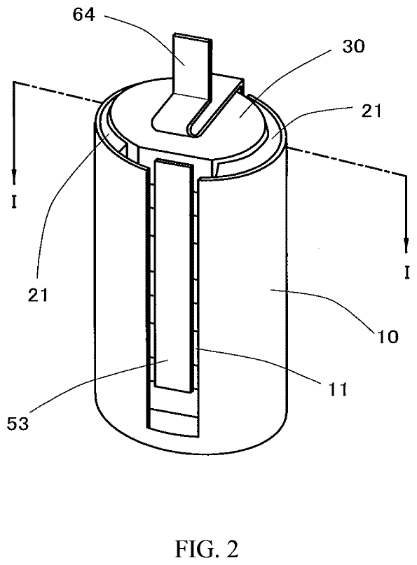

FIG. 2 shows a perspective view schematically representing the state of the electrode body housed inside the container 10 of FIG. 1. The electrode body 30 housed within the container 10 is formed by stacking multiple pellet-shaped power generating elements. One of the electrode layers (for example, the positive electrode layers) of each current collecting element constituting the electrode body 30 is electrically connected to each other through the conductive connection terminals (for example, the positive electrode layer connection terminals) by welding these connection terminals to lead 53. The other of the electrode layers (for example, the negative electrode layers) is electrically connected to each other through the conductive connection terminals (for example, the negative electrode layer connection terminals) by welding these connection terminals to lead 64. Furthermore, the lead 53 and the connection terminals for the electrode layers attached on lead 53, as well as the lead 64 and the connection terminals for the electrode layers attached to lead 64, are exposed to the outside of the container 10 from the slits 11, 11.

Between the container 10 and the electrode body 30, a foamed sheet (A) 21 is interposed such that one side surface of the foamed sheet (A) 21 is in close contact with the inner surface of the container 10, and the other side surface thereof is in close contact with the side surface of the electrode body 30. For example, when heated in a state where the electrode body 30 is accommodated inside the container 10, the resin sheet 20 foams to increase in thickness to become the foamed sheet 21. As s result, the surface on the opposite side of the inner surface of the container 10 comes into close contact with the side surface of the electrode body 30, as shown in FIG. 2. Furthermore, when a bonding layer is provided on the resin sheet for forming the foamed sheet (A) 21 such that the resin sheet is adhered to the inner surface of the container 10 through the bonding layer, the foamed sheet (A) 21 foamed by heating the resin sheet is adhered to the inner surface of the container 10 through the bonding layer, thus maintaining close contact.

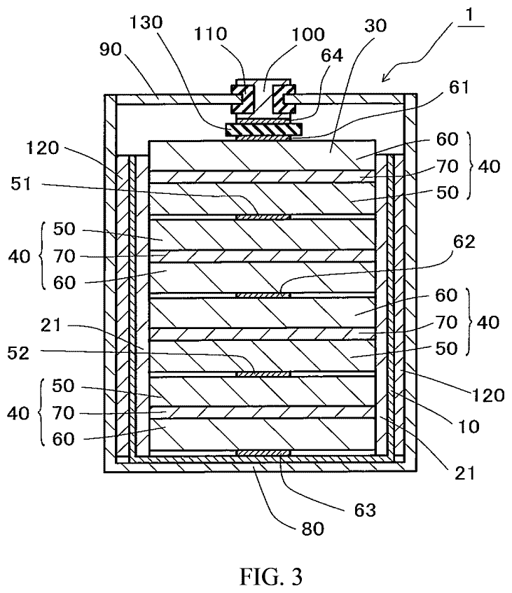

Next, an example of the solid electrolyte battery is explained with reference to a drawing. FIG. 3 is a schematic cross-sectional view representing an example of the solid electrolyte battery of the present invention. The cross-section shown in FIG. 3 corresponds to the cross-section at the I-I line of the container 10 that accommodates the electrode body 30 shown in FIG. 2.

The solid electrolyte battery 1 shown in FIG. 3 has an electrode body 30 composed of four pellet-shaped power generation elements 40 stacked, and an exterior body comprising a metal exterior can 80 having a cylinder shape with a bottom, and a metal lid body 90. The exterior can and the lid body can be formed of material such as aluminum or stainless steel.

The lid body 90 is provided with a metal terminal 100 attached via an insulating packing 110, which is made of material such as resin (such as polypropylene), glass hermetic, or ceramic hermetic. When using an electrolyte that decomposes due to moisture in the air, such as sulfides or hydrides, it is preferable to use glass hermetic or ceramic hermetic which can provide improved airtightness. The lid body 90 is then inserted into the opening of the exterior can 80, and the opening of the exterior can 80 is sealed by welding the joint between the two, thereby sealing the battery inside.

Each power generation element 40 of the electrode body 30 is composed of a positive electrode layer 50, a solid electrolyte layer 70, and a negative electrode layer 60, which are stacked in order. Also, four power generation elements 40 are stacked in the vertical direction in the drawing, and they are connected in parallel to each other as explained below, thereby constituting the electrode body 30.

The electrode body 30 is formed by stacking power generation elements 40 such that the electrode layers of the same polarity of adjacent power generation elements 40 face each other (for example, the power generation element 40 located at the top and the adjacently below power generation element 40 are stacked such that their respective positive electrode layers 50, 50 face each other).

Furthermore, between the positive electrode layers 50 of the power generation element 40 located at the top and the adjacently below positive electrode layer 50 of the power generation element 40, a positive electrode layer connection terminal 51 for conducting power from these positive electrode layers 50, 50 is arranged. Also, between the positive electrode layer 50 of the power generation element 40 positioned at the bottom and the adjacent upper positive electrode layer 50 of the power generation element 40, a positive electrode layer connection terminal 52 for conducting power from these positive electrode layers 50, 50 is also arranged. Although not shown in FIG. 3, the positive electrode layer connection terminals 51, 52 are conductively connected to the lead (lead 53 in FIG. 2) by means of welding or the like, and for example, the lead is electrically connected to the inner surface of the exterior can 80, which also serves as the positive terminal when it is welded.

Furthermore, on the upper side of the negative electrode layer 60 of the power generation element 40 located at the top, a negative electrode layer connection terminal 61 for drawing power in conduction with the negative electrode layer 60 is arranged. Additionally, between the negative electrode layer 60 of the power generation element 40 located second from the top and the adjacently below negative electrode layer 60 of the power generation element 40, a negative electrode layer connection terminal 62 for drawing power in conduction with these negative electrode layers 60 is arranged. Moreover, on the lower side of the negative electrode layer 60 of the power generation element 40 located at the bottom, a negative electrode layer connection terminal 63 for drawing power in conduction with the negative electrode layer 60 is arranged. Although not shown in FIG. 3, the negative electrode layer connection terminals 61, 62, 63 are electrically connected to the lead (lead 64 in FIG. 2) by welding or the like, and for example, the lead is electrically connected to the lower surface of a terminal 100 for functioning as a negative terminal by means of e.g., welding.

In FIG. 3, the solid electrolyte battery is shown as an embodiment in which the exterior can 80 also serves as a positive terminal and the terminal 100 functions as a negative terminal, but if necessary, the exterior can 80 can be configured to serve as a negative terminal and the terminal 100 can be configured to function as a positive terminal.

The electrode body 30 is housed within the container 10 and enclosed by the exterior body. Also, between the electrode body 30 and the container 10, a foamed sheet (A) 21 is interposed. One side surface of the foamed sheet (A) 21 adheres closely to the side surface of the electrode body 30, and the other side thereof adheres closely to the inner surface of the container 10, thereby securing the electrode body 30 in place.

As shown in FIG. 3, in the solid electrolyte battery of the present invention, an electrode body, which is composed of multiple pellet-shaped power generating elements that are stacked, is housed in the container, such that both the container and the electrode body are in close contact with the foamed sheet (A) to fix the electrode body in the container (that is, the positions of the power generating elements constituting the electrode body are fixed within the container). Therefore, when e.g., wiring is provided in a state where the container containing the electrode body is in an exterior body (exterior can), misalignment between the power generating elements does not occur, thereby improving workability. As a result, high productivity of the solid electrolyte battery of the present invention can be ensured. Since misalignment between the power generating elements constituting the electrode body does not occur even in a battery state, high reliability can also be ensured. Furthermore, the container prevents contact between the electrodes of the power generating elements constituting the electrode body and the inner surface of the exterior can which also serves as a counter terminal, thereby effectively preventing short circuits. To fix the electrode body within the container by the foamed sheet (A), one side surface of the foamed sheet (A) comes into close contact with the inner surface of the container and the other side surface thereof comes into close contact with the side surface of the electrode body. However, as long as the position of the electrode body can be fixed within the container, it is permissible, for example, to have only a part of one side surface of the foamed sheet (A) in contact with the inner surface of the container, or to have only a part of the other side surface of the foamed sheet (A) in contact with the side surface of the electrode body.

Furthermore, the electrode body can be housed in the container and then a foamed sheet (A) can be formed to fix the electrode body inside the container. Therefore, for example, when housing the electrode body, the opening diameter of the container, including the sheet for forming the foamed sheet (A), can be made larger to improve workability, followed by fixing the electrode body inside the container by forming the foamed sheet (A) through simple operations such as heating. As a result, in the solid electrolyte battery of the present invention, the reduction in production efficiency due to an increase in manufacturing steps involving the accommodation of the electrode body in the container and the fixing of the electrode body within the container is suppressed as much as possible.

Furthermore, in the solid electrolyte battery 1 shown in FIG. 3, a foamed sheet (B) 120 is interposed between the exterior can 80 and the container 10 that accommodates the electrode body 30. One side surface of the foamed sheet (B) 120 closely adheres to the outer surface of the container 10, and the other side surface thereof closely adheres to the inner surface of the exterior can 80. As a result, since the position of the container 10 inside the exterior body is fixed even when the battery is used in the environment subject to vibrations or the like, the internal wiring is less likely to come loose, or the displacement of the power generating elements can be more effectively suppressed, thereby enabling a more reliable battery. It should be noted that the fixation of the container within the exterior body by the foamed sheet (B) can be accomplished by making one side surface of the foamed sheet (B) adhere to the outer surface of the container while making the other side surface thereof adhere to the inner surface of the exterior body. However, as long as the position of the container within the exterior body can be fixed, for example, it is also acceptable for one side surface of the foamed sheet (B) to adhere partially to the outer surface of the container, or for the other side surface of the foamed sheet (B) to adhere partially to the inner surface of the exterior body.

A spacer 130 is arranged between the electrode body 30 and the terminal 100, and the electrode body 30 (stacked power generation element 40, respectively) is pressed toward the bottom of the exterior can 80 by the spacer 130. As will be described later, the connecting terminals that connect the electrode layers of each of the power generation elements 40 can be, or might not be, fixed to the adjacent electrode layers. Even if the connecting terminals are not fixed to the electrode layers, the action of the spacer 130 allows good connection between the connecting terminals and the electrode layers, thereby enabling a solid electrolyte battery with superior characteristics. The spacer 130 can be made of a rubber plate or a metal spring (such as a leaf spring).

Next, the details of the solid electrolyte battery of the present invention will be described. It is noted that the solid electrolyte battery of the present invention includes both primary and secondary batteries.

### Container

The container can be made of any insulating material. The example thereof can include resins such as polyolefins such as polypropylene or polyethylene; polystyrene; aramid; polyamide-imide; polyimide; nylon; polyesters such as polyethylene terephthalate (PET); or polyarylate. The thickness of the container (the thickness of the resin sheet that makes up the container) is preferably 100 to 1,000 μm.

As shown in FIG. 3, the container can be provided with a slit for exposing the connection terminal for connecting the positive electrode layers to each other or the connection terminal for connecting the negative electrode layers to each other to the outside of the container as needed. However, for example, when the power generation elements are connected in series to form an electrode body, the slit might not be required. In a case of forming an electrode body by connecting the power generation elements in parallel as shown in FIG. 3, when leads are connected to the connection terminals to connect the positive electrode layers to each other or to connect the negative electrode layers to each other, it is possible to work at the area having the slit in a condition where the power generation elements are housed in the container. Therefore, when housing each of the power generation elements in the container to heat to form the foamed sheet (A), the power generation elements can be connected to each other in a state where each of the power generation elements is fixed by the foamed sheet (A). As a result, positional misalignment between the power generation elements during connection can be prevented, thereby improving the productivity of the electrode body. Consequently, the productivity of the solid electrolyte battery can be enhanced.

The width of the slit in the container only needs to be enough to allow the electrode layer connection terminals and the leads attached to these terminals to be sufficiently exposed from each slit. However, if the width is too large, there is a risk that the strength of the container might be insufficient. Therefore, it is preferable that the width (or the total width if there are multiple slits) can be 30% or less of the length of the outer perimeter of the container when it is seen it in a plan view.

### Foamed Sheet (A) and Foamed Sheet (B)

The foamed sheet (A) and the foamed sheet (B) can be formed by using a sheet (a resin sheet) that foams upon heating to cause foaming. It is preferable that the sheet that foams upon heating has a bonding layer on one side. Various types of foaming sheets can be used as a sheet for forming the foamed sheet (A) and the foamed sheet (B). However, it is preferable to use a sheet in which a foaming agent is kneaded into a resin of various kinds such as epoxy resin, urethane resin, silicone resin, polyethylene, polypropylene, polyester, polystyrene, and acrylic resin, or into various rubbers such as polybutadiene and polyisoprene, followed by molding the resin into sheet form. As the foaming agent, materials that generate N₂, CO₂, H₂O, or the like upon heating can be used. When using a solid electrolyte that is highly reactive with moisture, such as a sulfide-based solid electrolyte or a hydride-based solid electrolyte, it is undesirable to use foaming agents that generate H₂O. Moreover, there are products in which components that generate gas upon heating are enclosed in microcapsules. By using these products at a temperature range where the gas generated from foaming does not escape from the microcapsules (about 10 to 30° C. lower than the maximum foaming temperature), the foamed resin remains enclosed within the microcapsules. This makes it unnecessary to be concerned about a decrease in battery performance due to generated gas. Therefore, it is more preferable to use it. The examples of the microcapsule type foaming agents include “KUREHA Microsphere” (product name) manufactured by Kureha Corporation, “MATSUMOTO Microsphere” (product name) manufactured by Matsumoto Yushi-Seiyaku Co., Ltd, “Expancel” (product name) manufactured by Japan Fillite Co., Ltd, and “ADVANCELL EM” (product name) manufactured by Sekisui Chemical Co., Ltd. The particle size of the microcapsules is preferably 5 to 100 μm before foaming, and the maximum size is preferably less than half of the thickness of the foamed sheet. The thickness of the foamed sheet (A) or the foamed sheet (B) (thickness after foaming) is preferably 100 to 1,000 μm.

The foamed sheet (A) is arranged at at least a part between the inner surface of the container and the electrode body, but from the viewpoint of properly securing the electrode body, it is preferable that the foamed sheet (A) is present at 50% or more of the total area of the inner surface of the container (excluding the area of the slit if the container has such a slit). In addition, it is also acceptable that the foamed sheet (A) is present on the entire inner surface of the container (100% of the inner surface area thereof).

Also, the foamed sheet (B) can be disposed at least in part between the outer surface of the container and the inner surface of the exterior can, but from the viewpoint of satisfactorily securing the container holding the electrode body, it is preferable that the foamed sheet (B) is present at an area of 50% or more of the total surface area of the outer surface of the container (excluding the area of the slit if the container has such a slit). Additionally, it is acceptable that the foamed sheet (B) is present over the entire outer surface of the container (100% of the outer surface area thereof).

### Cathode Layer

The positive electrode layer of the solid electrolyte battery can be formed, for example, by molding a positive electrode composition containing a positive electrode active material.

When the solid electrolyte battery is a primary battery, the positive electrode active material can be the same as the positive electrode active material conventionally used in non-aqueous electrolyte primary batteries. Specifically, the example thereof can include: manganese dioxide; lithium-containing manganese oxides [for example, LiMn₃O₆ or composite oxides that have the same crystal structure as manganese dioxide (β-type, γ-type, or a structure in which ≢-type and γ-type coexist) and a lithium content of 3.5 mass % or less, preferably 2 mass % or less, more preferably 1.5 mass % or less, particularly preferably 1 mass % or less]; lithium-containing composite oxides such as LiₐTi_{5/3}O₄ (4/3≤a<7/3); vanadium oxides; niobium oxides; titanium oxides; sulfides such as iron disulfide; fluorinated graphite; silver sulfides such as Ag₂S; nickel oxides such as NiO₂; and so on.

When the solid electrolyte battery is a secondary battery, there are no particular restrictions on the positive electrode active material, as long as it is a positive electrode active material conventionally used in non-aqueous electrolyte secondary batteries, that is, an active material capable of storing and releasing lithium ions. Specific examples of the positive electrode active materials can include: spinel-type lithium manganese composite oxides represented by LiMᵣMn₂₋ᵣO₄ (where M is at least one element selected from the group consisting of Li, Na, K, B, Mg, Ca, Sr, Ba, Ti, V, Cr, Zr, Fe, Co, Ni, Cu, Zn, Al, Sn, Sb, In, Nb, Ta, Mo, W, Y, Ru, and Rh, and 0≤r≤1);
layered compounds represented by LiᵣMn₍₁₋ₛ₋ᵣ₎NiₛMₜO₍₂₋ᵤ₎Fᵥ (where M is at least one element selected from the group consisting of Co, Mg, Al, B, Ti, V, Cr, Fe, Cu, Zn, Zr, Mo, Sn, Ca, Sr, and W, 0.8≤r≤1.2, 0<s<0.5, 0≤t≤0.5, u+v<1, −0.1≤u≤0.2, 0≤v≤0.1);
lithium cobalt composite oxides represented by LiCo₁₋ᵣMrO₂ (where M is at least one element selected from the group consisting of Al, Mg, Ti, V, Cr, Zr, Fe, Ni, Cu, Zn, Ga, Ge, Nb, Mo, Sn, Sb, and Ba, and 0≤r≤0.5);
lithium nickel composite oxides represented by LiNi₁₋ᵣMᵣO₂ (where M is at least one element selected from the group consisting of Al, Mg, Ti, Zr, Fe, Co, Cu, Zn, Ga, Ge, Nb, Mo, Sn, Sb, and Ba, and 0≤r≤0.5);
olivine-type composite oxides represented by Li₁₊ₛM₁₋ᵣNᵣPO₄Fₛ (where M is at least one element selected from the group consisting of Fe, Mn, and Co, and N is at least one element selected from the group consisting of Al, Mg, Ti, Zr, Ni, Cu, Zn, Ga, Ge, Nb, Mo, Sn, Sb, V, and Ba, 0≤r≤0.5, 0≤s≤1 ); and
pyrophosphate compounds represented by Li₂M₁₋ᵣNᵣP₂O₇ (where M is at least one element selected from the group consisting of Fe, Mn, and Co, and N is at least one element selected from the group consisting of Al, Mg, Ti, Zr, Ni, Cu, Zn, Ga, Ge, Nb, Mo, Sn, Sb, V, and Ba, 0≤r≤0.5). Any one of these can be used alone, or two or more can be used in combination.

In the case where the solid electrolyte battery is a secondary battery, the average particle size of the positive electrode active material is preferably 0.1 μm or more, more preferably 0.5 μm or more and preferably 25 μm or less, more preferably 10 μm or less, from the viewpoint of reducing side reactions that cause capacity deterioration of the battery and increasing the density of the positive electrode. The positive electrode active material can be a primary particle or a secondary particle in which primary particles are aggregated. When the positive electrode layer contains a solid electrolyte, using a positive electrode active material with an average particle size within the above range allows for more interface with the solid electrolyte, thereby further improving the load characteristics of the battery.

The average particle size of the positive electrode active material described in this specification, as well as the average particle size of other particles (such as solid electrolytes), means the value of the 50% diameter (D₅₀) in the cumulative volume fraction based on volume when calculating the integrated volume from the smaller particles, by using a particle size distribution measuring device (such as the Microtrack Particle Size Distribution Measuring Device ‘HRA9320’ manufactured by Nikkiso Co., Ltd.).

When the positive electrode layer includes a solid electrolyte, it is preferable that the positive electrode active material has a reaction suppressing layer on its surface to inhibit a reaction with the solid electrolyte contained in the positive electrode layer.

When the positive electrode active material comes into direct contact with the solid electrolyte in the positive electrode layer, there is a risk that the solid electrolyte is oxidized to form a resistance layer, thereby leading to a decrease in ionic conductivity within the layer. By providing a reaction suppression layer on the surface of the positive electrode active material to suppress reactions with the solid electrolyte and to prevent direct contact between the positive electrode active material and the solid electrolyte, it is possible to suppress the decrease in ionic conductivity within the positive electrode layer due to the oxidation of the solid electrolyte.

The reaction suppression layer can be made of a material that has ion conductivity and can suppress the reaction between the positive electrode active material and the solid electrolyte. The examples of the material that can constitute the reaction suppression layer can include an oxide containing Li and at least one element selected from the group consisting of Nb, P, B, Si, Ge, Ti, Zr, Ta, and W; more specifically, a Nb-containing oxide such as LiNbO₃, Li₃PO₄, Li₃BO₃, Li₄SiO₄, Li₄GeO₄, LiTiO₃, LiZrO₃, Li₂WO₄ and the like. The reaction suppression layer can contain only one of these oxides, or it can contain two or more. Furthermore, a plurality of these oxides can form a composite compound. Among these oxides, it is preferable to use Nb-containing oxides, and it is more preferable to use LiNbO₃.

The reaction suppression layer is preferably present on the surface in an amount of 0.1 to 2.0 parts by mass per 100 parts by mass of the positive electrode active material. Within the range above, the reaction between the positive electrode active material and the solid electrolyte can be favorably suppressed.

The methods for forming a reaction suppression layer on the surface of the positive electrode active material include the sol-gel method, mechanofusion method, CVD method, PVD method, and ALD method.

The content ratio of the positive electrode active material in the positive electrode layer is preferably 20 to 95 mass %.

The example of the conductive assistant for the positive electrode can include carbon material such as carbon black (thermal black, furnace black, channel black, Ketjen black, acetylene black, etc.), graphite (natural graphite, artificial graphite), graphene, vapor-grown carbon fibers, carbon nanofibers, and carbon nanotubes; powders of metals such as Cu, Ni, Al, Au and Pd, and an alloy thereof, and a porous body thereof; and the like. Any of these materials can be used alone or in combination of two or more. The content ratio of the conductive assistant in the positive electrode layer is preferably 0.1 to 15 mass %.

The positive electrode layer can include a solid electrolyte. The solid electrolyte used for the positive electrode layer is not particularly limited as long as it has Li ion conductivity. The examples to be used can include a sulfide-based solid electrolyte, a hydride-based solid electrolyte, a halide-based solid electrolyte, and an oxide-based solid electrolyte.

As the sulfide-based solid electrolyte, glass particles such as Li₂S—P₂S₅, Li₂S—SiS₂, Li₂S—P₂S₅—GeS₂, and Li₂S—B₂S₃ can be exemplified. In addition, in recent years, because of their high Li-ion conductivity, gained attention to be used are thio-LISICON type materials [Li₁₀GeP₂S₁₂, Li_{9.54}Si_{1.74}P_{1.44}S_{11.7}Cl_{0.3}, which can be represented by the formula Li_{12-12a-b+c+6d-e}M¹_{3+a-b-c-d}M²_{b}M³_{c}M⁴_{d}M⁵₁₂₋ₑXₑ (where M¹ is Si, Ge, or Sn, M² is P or V, M³ is Al, Ga, Y or Sb, M⁴ is Zn, Ca or Ba, M⁵ is S, or S and O, and X is F, Cl, Br, or I, with 0≤a<3, 0≤b+c+d≤3, 0≤e≤3), and an argyrodite-type material [e.g., Li₆PS₅Cl, which can be represented by Li₇₋ₖPS₆₋ₖXₖ (where X represents one or more halogen elements and 0.2<k<2.0), Li_{7-f+g}PS_{6-f}Cl_{f+g} (where 0.05≤g≤0.9, −3.0f+1.8≤g≤−3.0f+5.7), or Li₇₋ₕPS₆₋ₕClᵢBrⱼ (where h=i+j, 0<h≤1.8, 0.1≤i/j≤10.0)].

The examples of the hydride-based solid electrolyte can include LiBH₄, a solid solution of LiBH₄ and the following alkali metal compounds (for example, those in which the molar ratio of LiBH₄ to the alkali metal compound is 1:1 to 20:1), and the like. The example of the alkali metal compound in the solid solution can include at least one selected from the group consisting of lithium halides (such as LiI, LiBr, LiF, and LiCl), rubidium halides (such as RbI, RbBr, RbF, and RbCl), cesium halides (such as CsI, CsBr, CsF, and CsCl), lithium amide, rubidium amide, and cesium amide.

The examples of the halide-based solid electrolyte can include monoclinic LiAICl₄, defective spinel type or layered-structured LiInBr₄, and monoclinic Li₆₋₃ₘYₘX₆ (where 0<m<2 and X═Cl or Br). The other known solid electrolytes that can be used include those described in, for example, WO 2020/070958 and WO 2020/070955.

The examples of the oxide-based solid electrolytes include Li₂O—Al₂O₃—SiO₂—P₂O₅—TiO₂ glass ceramics, Li₂O—Al₂O₃—SiO₂—P₂O₅—GeO₂ glass ceramics, garnet-type Li₇La₃Zr₂O₁₂, NASICON-type Li_{1+O}A_{1+O}Ti_{2-O}(PO₄)₃, Li₁₊ₚAl₁₊ₚGe₂₋ₚ(PO₄)₃, and perovskite-type Li_{3q}La_{2/3-q}TiO₃.

Among these solid electrolytes, it is preferable to use a sulfide-based solid electrolyte because of its high Li ion conductivity. It is more preferable to use a sulfide-based solid electrolyte containing Li and P. It is yet more preferable to use an argyrodite-type sulfide-based solid electrolyte having high Li ion conductivity and high chemical stability.

The content of the solid electrolyte in the positive electrode layer is preferably 4 to 80 mass %.

The positive electrode layer can include a binder, but the binder does not need to be included, for example, when a sulfide-based solid electrolyte is included such that the powders of the positive electrode composition mixture powder are poured into a molding die and pressed into a shape while ensuring good moldability without using the binder.

The example of the binder that can be contained in the positive electrode layer can include a fluororesin such as PVDF.

When the binder is required in the positive electrode layer, the content ratio is preferably 15% by mass or less, and is preferably 0.5% by mass or more. On the other hand, in the case where moldability can be obtained in the positive electrode layer without the need of the binder, the content ratio thereof is preferably 0.5 mass % or less, more preferably 0.3 mass % or less, and even more preferably 0 mass % (i.e., no binder is contained).

The positive electrode layer can be provided with a current collector. The current collector for the positive electrode layer can be made of a metal foil or a sheet-shaped conductive porous substrate such as a punched metal, a mesh, an expanded metal, or a foamed metal, made of e.g., aluminum or stainless steel; or a carbon sheet. As the sheet-shaped conductive porous substrate, it is preferable to use a foamed metal porous body. The example of the foamed metal porous body can include “CELMET (registered trademark)” manufactured by Sumitomo Electric Industries, Ltd.

The positive electrode layer can be manufactured, for example, through a process comprising a step of preparing a positive electrode composition by mixing a positive electrode active material, a conductive assistant, a solid electrolyte, and optionally a binder if necessary, and the like, which is compressed by pressure molding or the like to form a molded body thereof.

In the case of a positive electrode layer having a current collector, it can be formed by pressing the current collector onto a pressure-molded body of the positive electrode composition as obtained above.

The thickness of the positive electrode layer can be usually 50 μm or more, but from the viewpoint of increasing the capacity of the battery, it is preferable to be 200 μm or more. Additionally, the thickness of the positive electrode layer can be generally 2,000 μm or less.

The thickness of the current collector of the positive electrode layer is preferably 0.01 to 0.1 mm.

### Negative Electrode Layer

The negative electrode layer of the solid electrolyte battery can be formed, for example, by molding a negative electrode composition containing a negative electrode active material.

When the solid electrolyte battery is a primary battery, the negative electrode active material can be lithium metal, a lithium alloy (lithium-aluminum alloys, lithium-indium alloys, etc.) and etc.

When the solid electrolyte battery is a secondary battery, the negative electrode active material that can be used can include one or a mixture of two or more carbon-based materials capable of absorbing and releasing lithium, such as graphite, thermally decomposed carbon, coke, glassy carbon, calcined products of organic polymer compounds, mesocarbon microbeads (MCMB), and carbon fibers. In addition, as the negative electrode active material, it is possible to use a single body including an element such as Si, Sn, Ge, Bi, Sb, In; a compound or alloy thereof; a compound such as lithium-containing nitrides or lithium-containing oxides, which can be charged and discharged at low voltages close to those of lithium metal; lithium metal; and a lithium/aluminum alloy. For example, a metal oxide such as Li₄Ti₅O₁₂, TiO₂, NbO_{25-δ} (0≤δ≤0.5), MoO_{3-δ} (0≤δ≤1), WO_{3-δ} (0≤δ≤1), TiNb₂O₇; and a metal sulfides such as WS₂, MoS₂; one or a mixture of two or more of these can also be used as a negative electrode active material.

The content ratio of the negative electrode active material in the negative electrode layer is preferably 50 to 95 mass %.

The negative electrode layer can include a solid electrolyte. The solid electrolyte contained in the negative electrode layer can include one or more of the sulfide-based solid electrolyte, hydride-based solid electrolyte, or oxide-based solid electrolyte which was already exemplified as a solid electrolyte to be contained in the positive electrode layer. Among the solid electrolytes exemplified above, it is preferable to use a sulfide-based solid electrolyte because of high Li-ion conductivity and enhancing the function of the negative electrode layer, and it is more preferable to use an argyrodite-type sulfide-based solid electrolyte.

The content ratio of the solid electrolyte in the negative electrode layer is preferably 4 to 70 mass %.

The negative electrode layer can contain a conductive assistant. The examples thereof can include carbon material such as graphite (natural graphite, artificial graphite), graphene, carbon black, vapor-grown carbon fibers, carbon nanofibers, and carbon nanotubes. The content ratio of the conductive assistant in the negative electrode layer is preferably 1 to 10 mass %.

The negative electrode layer can contain, or does not need to contain, a binder. The example thereof can include the same binder as previously described to be included in the positive electrode layer. It is noted that when good moldability can be ensured in forming the negative electrode layer even without using a binder, for instance, in cases where a sulfide-based solid electrolyte is contained in the negative electrode layer, the negative electrode layer does not need to contain a binder.

When a binder is required in the negative electrode layer, the content ratio thereof is preferably 15% by mass or less, and is preferably 0.5% by mass or more. On the other hand, in the case where good moldability can be obtained in the negative electrode layer without the need for a binder, the content ratio is preferably 0.5 mass % or less, more preferably 0.3 mass % or less, and even more preferably 0 mass % (i.e., no binder is contained).

The negative electrode layer can be provided with a current collector. The current collectors for the negative electrode layers can be made of a metal foil or a sheet-shaped conductive porous substrate such as a punched metal, a mesh, an expanded metal, and a foamed metal, made of e.g., copper or nickel; carbon sheets. As the sheet-shaped conductive porous substrate, it is preferable to use a foamed metal porous body. The example of the foamed metal porous body can include “CELMET (registered trademark)” manufactured by Sumitomo Electric Industries, Ltd.

The negative electrode layer can be manufactured, for example, through a process comprising a step of preparing a negative electrode composition by mixing a negative electrode active material, a conductive assistant, a solid electrolyte, and optionally a binder if necessary, and the like, which is then compressed by pressure molding or the like to form a molded body thereof.

In the case of a negative electrode layer having a current collector, it can be formed by pressing the current collector onto a pressure-molded body of the negative electrode composition as obtained above.

The thickness of the negative electrode layer can be usually 100 μm or more, but from the viewpoint of increasing the capacity of the battery, it is preferable to be 200 μm or more. Additionally, the thickness of the negative electrode layer can be generally 3,000 μm or less.

The thickness of the current collector of the negative electrode layer is preferably 0.01 to 0.1 mm.

### Solid Electrolyte Layer

The solid electrolyte layer in the solid electrolyte battery can include one or more of the sulfide-based solid electrolyte, the hydride-based solid electrolyte, or the oxide-based solid electrolyte which was already exemplified as a solid electrolyte to be contained in the positive electrode layer. Among the solid electrolytes as exemplified above, it is preferable to contain a sulfide-based solid electrolyte to improve the battery characteristics. It is more preferable to contain an argyrodite-type sulfide-based solid electrolyte.

The solid electrolyte layer can be formed by: e.g., a method of compressing a solid electrolyte by pressure molding; and a method in which a composition for forming a solid electrolyte layer is prepared by dispersing a solid electrolyte in a solvent, followed by applying it onto a substrate, a positive electrode or a negative electrode, followed by drying the composition, and, if necessary, performing pressure molding such as pressing.

Also, the solid electrolyte layer can be provided with a porous body such as a resin nonwoven fabric as a support.

The solvent for preparing a composition for a solid electrolyte layer composition is preferably selected not to cause deterioration of the solid electrolyte. In particular, since the sulfide-based solid electrolyte and the hydride-based solid electrolyte may cause a chemical reaction even in the presence of minute amounts of water, it is preferable to use a non-polar aprotic solvent such as a hydrocarbon solvent such as hexane, heptane, octane, nonane, decane, decalin, toluene, and xylene. In particular, it is more preferable to use an ultra-dehydrated solvent having a water content of 0.001% by mass (10 ppm) or less. In addition, the example thereof that can be used includes a fluorine-based solvent such as “Vertrel (registered trademark)” manufactured by Du Pont-Mitsui Fluorochemicals, “ZEOROLLA (registered trademark)” manufactured by Zeon Corporation, and “Novec (registered trademark)” manufactured by Sumitomo 3M Limited, as well as a non-aqueous organic solvent such as dichloromethane and diethyl ether.

The thickness of the solid electrolyte layer is preferably between 10 and 500 μm.

### Power Generation Element and Electrode Body

The power generation element is pellet-shaped and is formed by stacking a positive electrode layer, a solid electrolyte layer, and a negative electrode layer in order. The power generation element can be prepared by a method, for example, in which a positive electrode layer (or negative electrode layer) is pre-formed by pressing to be used as a substrate, onto which a solid electrolyte layer and a negative electrode layer (or positive electrode layer) is sequentially formed by pressing. Alternatively, a solid electrolyte layer is prepared by pressing in advance, and then, a positive electrode layer is pressed and formed on one side surface of the pre-formed solid electrolyte layer, and a negative electrode layer is pressed and formed on the other side surface of the solid electrolyte layer.

The shape of the power generation element in a plan view is not particularly restricted and can be circular, elliptical, or polygonal such as quadrangular etc.

The electrode body is formed by stacking multiple power generation elements and connecting adjacent power generation elements in parallel or series. When connecting power generation elements in parallel, for example, a method can be adopted such that adjacent power generation elements are stacked such that their electrode layers of the same polarity face each other as shown in FIG. 3.

Furthermore, when connecting power generating elements in series, for example, a method can be adopted such that adjacent power generating elements are stacked so that their electrodes of opposite polarities face each other.

When connecting power generating elements in parallel or in series, a conductive connection can be made by interposing a conductive connection terminal between the opposing electrode layers. The connection terminal for electrically connecting the electrode layers can be fixed to either one of the opposing electrode layers, or it does not need to be be fixed to any electrode layer at all. When fixing the connection terminal to an electrode layer, the connection terminal can be, for example, welded to the collector of an electrode layer having a metal collector.

The number of power generation elements that the electrode body can possess is not particular restricted as long as there are multiple (two or more). Depending on the characteristics required for the solid electrolyte battery, it is possible to have 10, 20, or even more.

### Connection Terminal and Lead

A connection terminal (terminal that connects the electrode layers of adjacent power generating elements) for extracting power from the electrode layer of the power generating element, as well as a lead for connecting the terminals to each other can be made of stainless steel, nickel, aluminum, iron, copper, a clad material combining any of these metals, and a metal foil (plate) in which the material above is plated with nickel, chromium or nickel-chromium.

The thickness of a connection terminal or a lead made of a metal foil (plate) is preferably 10 to 100 μm. In addition, the size of the connection terminal or the lead is not particular restricted, but when it is exposed from a slit of the container to the outside of the container, the width thereof should be shorter than the width of the slit.

### Exterior Body

The exterior body of the solid electrolyte battery is not particularly limited; but since the enclosed electrode body is formed by stacking multiple power generating elements, it is preferable to have a shape having a bottomed cylindrical exterior can (polygonal tubular can, cylindrical can) and a lid, as shown in FIG. 3. The connection between the exterior can and the lid body can be made by welding or crimping via a gasket.

### Method for Manufacturing a Solid Electrolyte Battery

A solid electrolyte battery can be manufactured as follows. A sheet for forming a foamed sheet (A) (resin sheet 20 shown in FIG. 1) is placed on the inner surface of a container, into which an electrode body having stacked power generating elements is housed, or the electrode body is housed in a container with the electrode body having a sheet arranged on the side surface thereof. Under the situation, the electrode body is heated to form the foamed sheet (A). As a result, one surface of the foam sheet (A) closely adheres to the inner surface of the container, and the other surface thereof closely adheres to the side surface of the electrode body. In case of an electrode body where the power generating elements are connected in parallel, the connection between the power generating elements in the electrode body can be carried out, as described above, by using a container with a slit. In this way, each power generating element can be fixed inside the container with the foamed sheet (A) before making the connections.

The container, in which the electrode body is internally fixed with the foamed sheet (A), is accommodated into an exterior can. Then, it is provided with wiring if necessary, or it is fixed inside the exterior can with the foamed sheet (B) if necessary, before the opening of the exterior can is sealed with a lid body to form an exterior body, thereby obtaining a solid electrolyte battery. Additionally, the formation of the foamed sheet (B) (forming the foamed sheet (B) by causing foam of a sheet for the foamed sheet (B) upon heating) can also be performed after the exterior body is formed (after sealing).

There can be provided other embodiments than the description above without departing the gist of the present invention. The embodiment described above is an example only, and the present invention is not limited to the specific embodiment. The scope of the present invention should be construed primarily based on the claims, not to the description of the specification or the present application. Any changes within the terms of the claims and the equivalence thereof should be construed as falling within the scope of the claims.

### INDUSTRIAL APPLICABILITY

The solid electrolyte battery of the present invention can be applied to applications similar to those of conventional primary and secondary batteries. However, since it has excellent heat resistance as described above, it is particularly suitable for applications exposed to high temperatures.

### EXPLANATION OF THE REFERENCE

1. Solid electrolyte battery
10. Container
20. Resin sheet
21. Foamed sheet (A)
30. Electrode body
40. Power generation element
50. Positive electrode layer
51, 52. Positive electrode layer connection terminal
53. Lead
60. Negative electrode layer
61, 62, 63. Negative electrode layer connection terminal
64. Lead
70. Solid electrolyte layer
80. Exterior can
90. Lid
100. Terminal
110. Insulating Packing
120. Foamed sheet (B)
130. Spacer

1-10. (canceled)

11. A solid electrolyte battery, comprising:
an electrode body comprising:
a plurality of pellet-shaped power generation elements being stacked, wherein each of the plurality of the power generation elements comprises a positive electrode layer, a solid electrolyte layer and a negative electrode layer stacked in order;
a container housing the electrode body inside the container, the container being insulating;
a foamed sheet (A) arranged at at least a part between an inner surface of the container and the electrode body such that the electrode body is fixed within the container by the foamed sheet (A);
an exterior body enclosing the container, the exterior body comprising a cylindrical or a polygonal tubular exterior can; and
a foamed sheet (B) arranged at at least a part between the container and the exterior can, such that the foamed sheet (B) fixes the container within the exterior can.

12. The solid electrolyte battery according to claim 11, wherein the foamed sheet (A) has been foamed by heating.

13. The solid electrolyte battery according to claim 11, wherein the foamed sheet (A) comprises a bonding layer to bond the electrode body to the inner surface of the container.

14. The solid electrolyte battery according to claim 11, wherein the foamed sheet (B) has been foamed by heating.

15. The solid electrolyte battery according to claim 11, wherein the foamed sheet (B) comprises a bonding layer to bond an outer surface of the container or an inner surface of the exterior can.

16. The solid electrolyte battery according to claim 11, wherein the power generation elements that are adjacent are connected in series to each other.

17. The solid electrolyte battery according to claim 11, further comprising:
a positive electrode layer connection terminal that is conductive to the positive electrode layer and capable of deriving power from the positive electrode layer, and
a negative electrode layer connection terminal that is conductive to the negative electrode layer and capable of deriving power from the negative electrode layer,
wherein the power generation elements that are adjacent are connected in parallel through the positive electrode layer connection terminal and the negative electrode layer connection terminal.

18. The solid electrolyte battery according to claim 17, further comprising a slit on a side surface of the container to expose the positive electrode layer connection terminal and the negative electrode layer connection terminal to an outside of the container.

19. A method for manufacturing a solid electrolyte battery, comprising:
providing a container that is insulating;
providing an electrode body comprising multiple pellet-shaped power generation elements,
providing a sheet that foams upon heating at least at a portion between an inner surface of the container and a side surface of the electrode body;
housing the electrode body in the container;
housing the electrode body in an exterior body 80 comprising a cylindrical or a polygonal tubular exterior can, wherein a foamed sheet (B) is arranged at at least a part of a space between the container and the exterior can, such that the foamed sheet (B) fixes the container within the exterior can;
wherein when the sheet is heated, the sheet foams to fix the side surface of the electrode body to the inner surface of the container.
